(19) United States
(12) Patent Application Publication
(10) Pub. No.: US 2016/0230371 A1
(43) Pub. Date: Aug. 11, 2016

(54) GUARD SYSTEM FOR A SENSING DEVICE

(71) Applicant: Caterpillar Underground Mining Pty Ltd, South Burnie (AU)

(72) Inventor: Jason P. Musheno, Newnan, GA (US)

(73) Assignee: Caterpillar Underground Mining Pty Ltd, South Burnie (AU)

(21) Appl. No.: 14/615,563

(22) Filed: Feb. 6, 2015

(51) Int. Cl. E02F 9/26; E02F 3/34; E02F 3/38; G01D 11/24

(52) U.S. Cl. CPC E02F 9/26; G01D 11/245; E02F 3/34; E02F 3/38

(57) ABSTRACT

A guard system for a sensing device in a linkage assembly having a first linkage component and a second linkage component includes a tube member and a cover member. The tube member includes a base portion coupled to the first linkage component and a projecting portion extending from the base portion and coupled to the second linkage component. The projecting portion has a first surface facing the second linkage component and a second surface opposite to the first surface. The cover member is coupled to the projecting portion. The cover member includes a body having an internal surface configured to at least partly abut the second surface, and an external surface opposite to the internal surface. The body defines a cavity to receive the sensing device therein. The cover member includes a plate disposed adjacent to the external surface and configured to encloses the sensing device within the cavity.

### TECHNICAL FIELD

The present disclosure relates to a guard system for a sensing device, and more particularly to a guard system for a sensing device associated with a work tool.

### BACKGROUND

Typically, machines may include implements such as, a bucket, a grapple and the like to perform various operations. The implements may be moved to different positions to perform the operations. Such a movement may be accomplished by one or more linkage components and actuators associated therewith. In some cases, the machine may include a sensor apparatus associated with the linkage components to determine the position of the implement in the operating space of the machine.

During operation of the machine, there may be a risk of debris falling into the sensor apparatus and damaging the sensor apparatus. Further, the falling debris may clog the sensor apparatus and hinder the operation of the sensor apparatus. Typically, a guard is provided for the sensor apparatus in the machine. Conventional guards such as, guards shaped like a fender or an enclosure, covers the sensor apparatus within a region defined by the range of motion of the sensor apparatus. Additionally, in case of underground mining applications, rocks and/or debris may fall onto the linkage components from ceilings of a mining tunnel. Further, an impact loading in such applications may also be high. As such, the conventional guards may not be suitable.

U.S. Patent application Number 2013/0283648 describes a guard for a sensor apparatus in a tilting arrangement. The guard includes a first tubular portion supported on the tilting arrangement, a longitudinal portion extending from the first tubular portion, and a second tubular portion extending from the longitudinal portion. The first tubular portion provides a first cavity adapted to partially enclose a first mounting stud of the sensor apparatus. Similarly, the second tubular portion provides a second cavity adapted to partially enclose a second mounting stud of the sensor apparatus. Further, the longitudinal portion provides a recess adapted to partially enclose a lever member of the sensor apparatus.

### SUMMARY OF THE DISCLOSURE

In one aspect of the present disclosure, a guard system for a sensing device in a linkage assembly having a first linkage component and a second linkage component is provided. The guard system includes a tube member and a cover member. The tube member includes a base portion coupled to the first linkage component. The tube member also includes a projecting portion extending from the base portion and coupled to the second linkage component. The projecting portion has a first surface facing the second linkage component and a second surface opposite to the first surface. The cover member is coupled to the projecting portion. The cover member includes a body having an internal surface configured to at least partly abut the second surface of the projecting portion. An external surface of the body is opposite to the internal surface. The body defines a cavity configured to receive the sensing device therein. The cover member also includes a plate disposed adjacent to the external surface. The plate is configured to enclose the sensing device within the cavity. Further, the sensing device is coupled to the plate.

In another aspect of the present disclosure, a machine is provided. The machine includes a frame and an implement configured to perform an earth moving operation. The machine also includes a linkage assembly configured to move the implement with respect to the frame. The linkage assembly includes a tilt lever pivotally coupled to the implement and a lift arm coupled to the frame. The machine also includes a sensing device associated with the linkage assembly and a guard system for the sensing device. The guard system includes a tube member and a cover member. The tube member includes a base portion coupled to the first linkage component. The tube member also includes a projecting portion extending from the base portion and coupled to the second linkage component. The projecting portion has a first surface facing the second linkage component and a second surface opposite to the first surface. The cover member is coupled to the projecting portion. The cover member includes a body having an internal surface configured to at least partly abut the second surface of the projecting portion. An external surface of the body is opposite to the internal surface. The body defines a cavity configured to receive the sensing device therein. The cover member also includes a plate disposed adjacent to the external surface. The plate is configured to enclose the sensing device within the cavity. Further, the sensing device is coupled to the plate.

In yet another aspect of the present disclosure, sensor system for a linkage assembly having a first linkage component and a second linkage component is provided. The sensor system includes a sensing device. The sensing device includes a sensor body and a cable connected to the sensor body. The sensing device also includes a lever pivotally coupled to the sensor body and a mounting stud operatively connected to the lever and the second linkage component. The sensor system also includes a tube member. The tube member includes a base portion coupled to the first linkage component. The tube member also includes a projecting portion extending from the base portion and coupled to the second linkage component. The projecting portion has a first surface facing the second linkage component and a second surface opposite to the first surface. The sensor system further includes a cover member that is coupled to the projecting portion. The cover member includes a body having an internal surface configured to at least partly abut the second surface of the projecting portion. An external surface of the body is opposite to the internal surface. The body defines a cavity configured to receive the sensing device therein. The cover member also includes a plate disposed adjacent to the external surface. The plate is configured to enclose the sensing device within the cavity. Further, the sensing device is coupled to the plate.

Other features and aspects of this disclosure will be apparent from the following description and the accompanying drawings.

### BRIEF DESCRIPTION OF THE DRAWINGS

FIG. 1 is a side view of a machine having a work tool connected to a linkage assembly, according to an embodiment of the present disclosure;

FIG. 2 is a perspective view of a first linkage component of the linkage assembly showing a tube member, according to one embodiment of the present disclosure;

FIG. 3 is partial perspective view of a sensor system showing a cover member coupled the tube member, according to one embodiment of the present disclosure;

FIG. 4 is a perspective view of the tube member, according to an embodiment of the present disclosure;

FIG. 5 is a side perspective view of the cover member showing an external surface, according to one embodiment of the present disclosure; and

FIG. 6 is a side perspective view of the cover member showing an internal surface, according to one embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

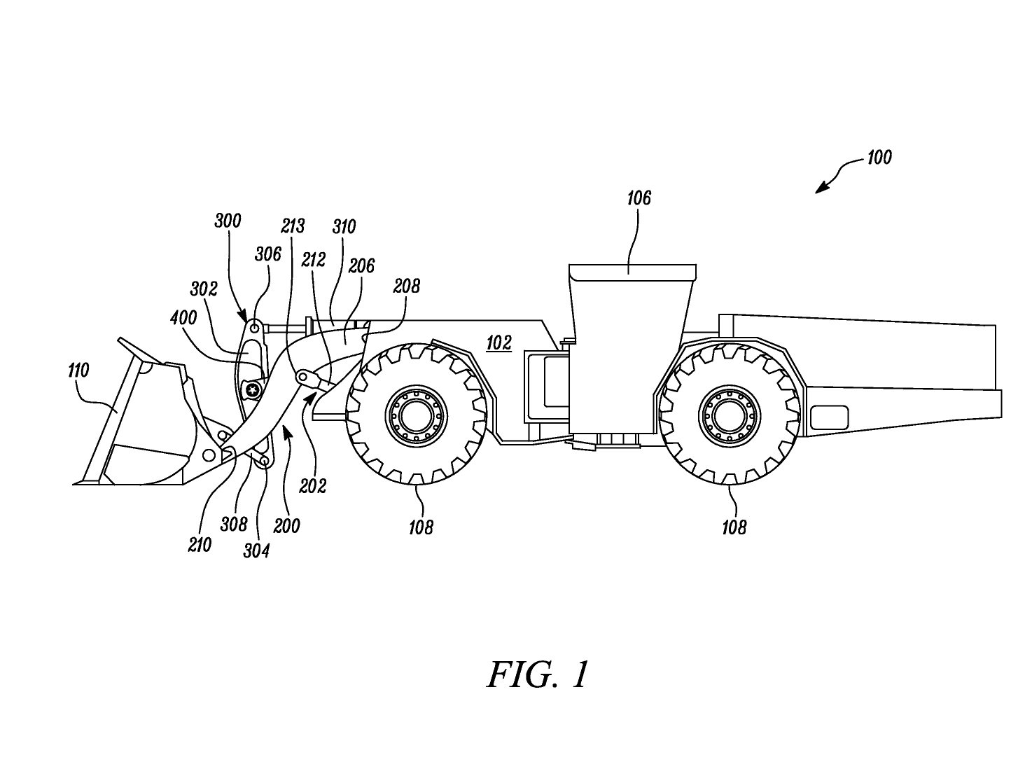

FIG. 1 illustrates a side view of a machine 100, according to an embodiment of the present disclosure. More specifically, the machine 100 may embody an underground wheel loader as shown in the illustrated embodiment. However, it may be contemplated that the machine 100 may be any other machine known in the art, such as a skid loader, a track loader, an excavator and the like, used for various industries including construction, mining, agriculture and transportation.

Referring to FIG. 1, the machine 100 may include a frame 102 to support various components of the machine 100. A powertrain or a drivetrain (not shown) may be provided on the machine 100 for the production and transmission of motive power. The powertrain may include a power source that may be located within an enclosure of the machine 100. The power source may include one or more engines, power plants or other power delivery systems like batteries, hybrid engines, and the like. It should be noted that the power source may also be external to the machine 100. A set of ground engaging members 106, such as wheels, may also be provided on the machine 100 for the purpose of mobility. The powertrain may further include a torque converter, transmission inclusive of gearing, drive shaft and other known drive links provided between the power source and the set of ground engaging members 106 for the transmission of motive power. Further, the machine 100 may include an operator cabin 108 which houses controls for operating the machine 100.

The machine 100 further includes an implement 110 connected to the frame 102. The implement 110 may be configured to move and/or tilt to different positions in order to perform earth moving operations such as, excavation, dumping and the like. In the present embodiment, the implement 110 is illustrated as a bucket, which may be used to scoop and/or lift the material. In various alternate embodiments, the implement 110 may be a blade, an auger, a fork, a snow plow, and the like.

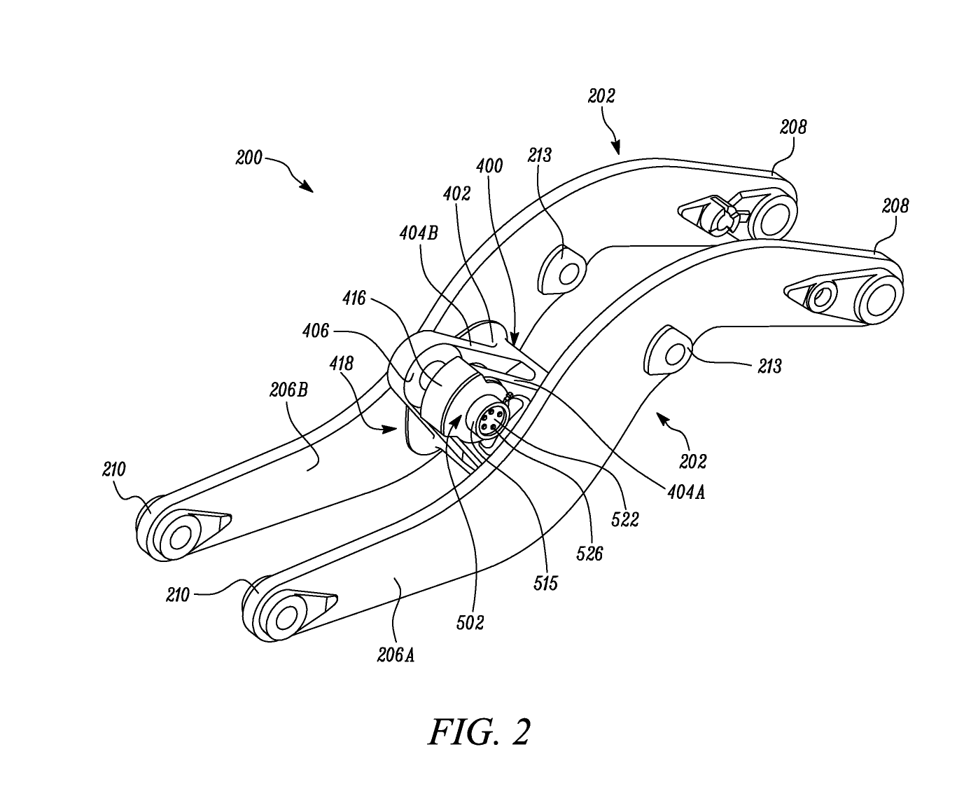

Referring to FIGS. 1 and 2, an exemplary linkage assembly 200 configured to move the implement 110 with respect to the frame 102 is illustrated. The linkage assembly 200 may include a lift arrangement 202 for controlling a raising or a lowering movement of the implement 110.

The lift arrangement 202 may include one or more first linkage components 206. In the illustrated embodiment, the lift arrangement 202 includes two first linkage components 206A, 206B (also collectively referred to as “the first linkage components 206”) in a spaced apart relationship. The first linkage components 206 may be pivotally coupled to the frame 102 adjacent to first ends 208 thereof. In an example, the first linkage components 206 may be coupled to the frame 102 via pivot pins. Further, second ends 210 of each of the first linkage components 206 may be pivotally coupled to the implement 110. In an example, the second ends 210 may be coupled proximate to a bottom of the implement 110 via a coupler (not shown). In the illustrated embodiment, the first linkage component 206 is a lift arm.

The lift arrangement 202 may also include one or more lift actuators 212 (shown in FIG. 1). In the illustrated embodiment, the lift arrangement 202 may include two lift actuators 212 associated with the corresponding first linkage components 206. However, it may also be contemplated to implement the lift arrangement 202 using a single first linkage component 206 and a corresponding lift actuator 212, or two first linkage components 206 driven by the single lift actuator 212.

The lift actuators 212 may be coupled to each of the first linkage components 206 at an intermediate location 213 (shown in FIG. 2) between the first end 208 and the second end 210. The lift actuators 212 may be configured to provide an actuating force for a movement of the corresponding first linkage components 206.

The linkage assembly 200 further includes a tilt arrangement 300 (shown in FIG. 1) that is configured to control a rotatory and/or tilting movement of the implement 110. The tilt arrangement 300 includes a second linkage component 302 having a first end 304 and a second end 306. In the illustrated embodiment, the second linkage component 302 is a tilt lever.

The tilt arrangement 300 may also include a connecting member 308. The first end 304 of the second linkage component 302 is pivotally coupled to the implement 110 via the connecting member 308. Alternatively, the first end 304 may be directly coupled to the implement 110. The tilt arrangement 300 may also include a tilt actuator 310 that is pivotally connected to the second end 306 of the second linkage component 302. The tilt actuator 310 may be configured to provide an actuation force for a rotary/tilting movement of the implement 110 with respect to the second linkage component 302.

During operation of the machine 100, the first and second linkage components 206, 302 and the implement 110 may be moved to different positions in order to perform different operations such as loading, dumping, excavating, and the like. The movement of the first and second linkage components 206, 302 and/or the implement 110 may be controlled by the corresponding lift and tilt actuators 212, 310 which are coupled to these parts as described above. Accordingly, based on the movement of the implement 110, the machine 100 may perform the required operation.

In an example, the lift actuators 212 and the tilt actuators 310 may be hydraulic cylinders driven by pressurized hydraulic fluid. In such a case, an extending movement of the lift actuator 212 may raise the first linkage component 206 while a retracting movement of the lift actuator 212 may lower the first linkage component 206. Similarly, a linear movement of the tilt actuator 310 translates to a tilt movement of the implement 110, via the second linkage component 302.

Alternatively, other types of lift and tilt actuators 212, 310 such as, pneumatic linear actuators, piezoelectric actuators, electro-mechanical actuators, and the like may be used to provide actuation force for corresponding movement of the implement 110.

It may also be noted that the linkage assembly 200 and the implement 110 of the machine 100 may vary based on the type of machine or the type of operation or task required to be carried out by the machine 100. For example, the first linkage component 206 may be a lift arm. Further, the second linkage component 302 may be a tilt lever. Each of the first linkage component 206 and the second linkage component 302 may be coupled to suitable parts such as, the implement 110, the frame 102 and the like by various linkage mechanisms known in the art.

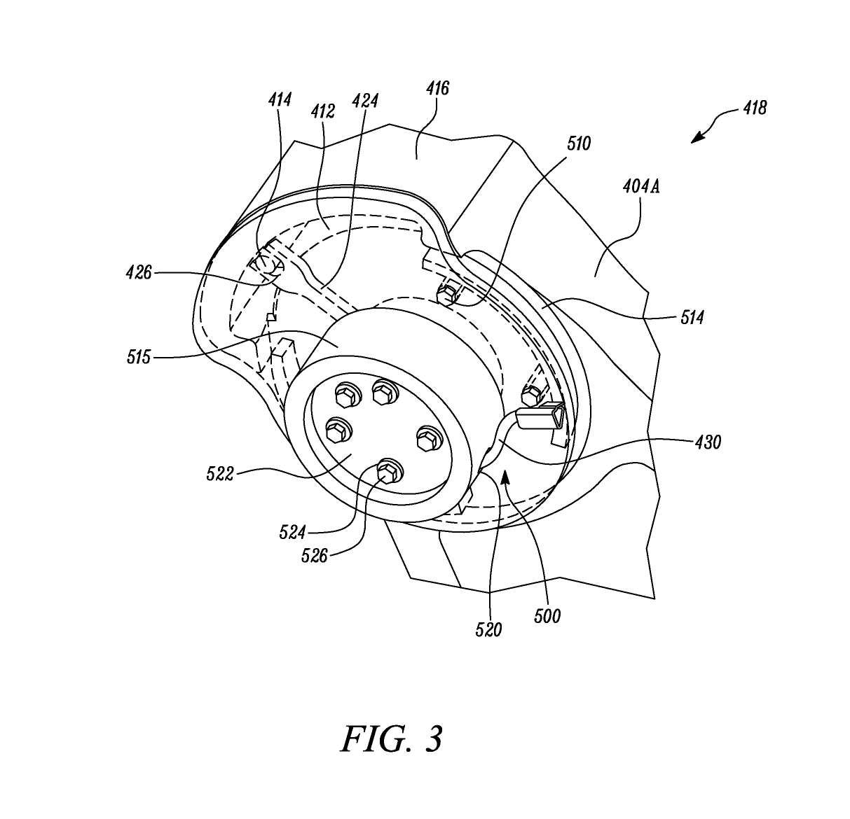

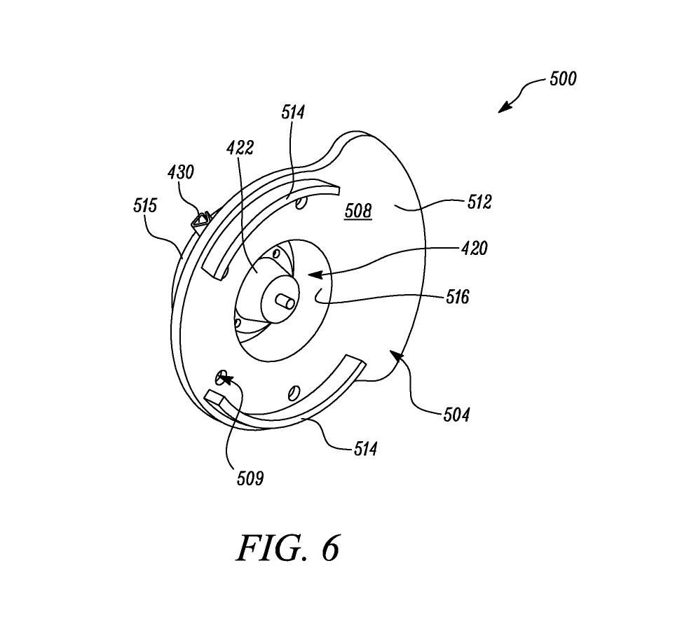

Referring to FIGS. 3 to 6, the machine 100 further includes a sensor system 418 associated with the linkage assembly 200. The sensor system 418 includes a sensing device 420 (best shown in FIG. 6) configured to detect a movement of the second linkage component 302. The sensing device 420 may include a sensor body 422 and a lever member 424 pivotally coupled to the sensor body 422. The lever member 424 may be configured to move in conjunction with the second linkage component 302, the details of which will be explained with reference to FIGS. 3 to 6.

The sensing device 420 may further include a sensor probe (not shown) and a rotational angle detecting device (not illustrated). The sensor probe, in conjunction with the rotational angle detecting device, may determine the movement of the lever member 424. The sensor probe may be disposed in the sensor body 422.

The sensor probe may include, for example, a magneto-resistive sensor, an interferometer, an optical encoder, a photo-reflective sensor, or the like. As may be understood by a person having ordinary skill in the art that, the sensor probe may read one or more markings or patterns on the lever member 424, based on the type of sensor probe, and generates an electric signal proportional to the movement of the lever member 424. The electric signal may be transmitted to the rotational angle detecting device via a cable 430. The electric signal may be processed by the rotational angle detecting device to determine a tilting movement of the implement 110.

The sensor system 418 further includes a guard system 500 for the sensing device 420 in the linkage assembly 200 having the first linkage component 206 and the second linkage component 302. The sensing device 420 may be configured to be integrated with the guard system 500.

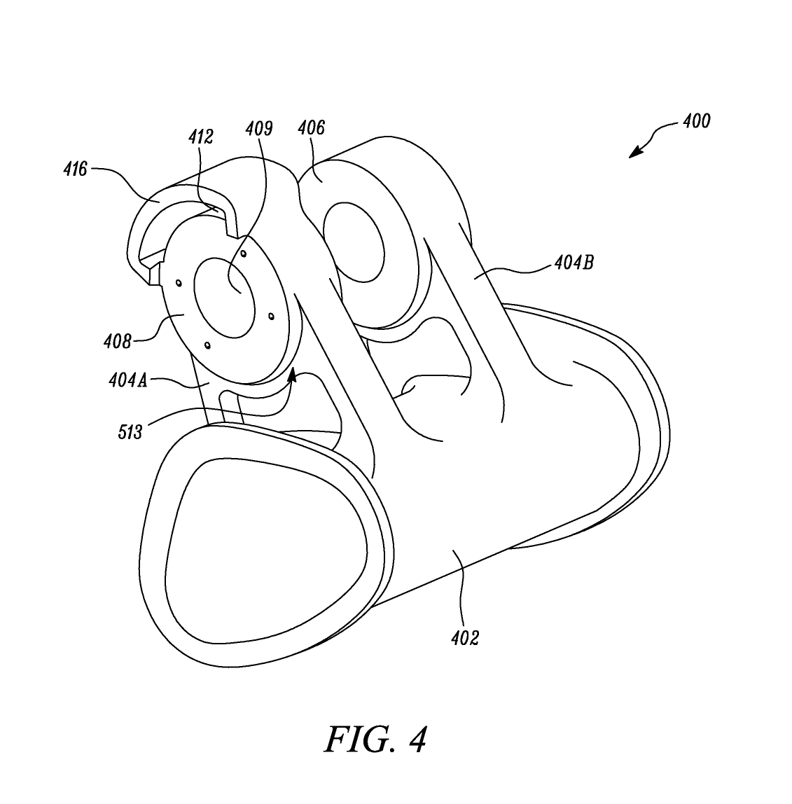

The guard system 500 includes a tube member 400. Referring to FIGS. 3 and 4, the tube member 400 includes a base portion 402 coupled to each of the first linkage components 206. The tube member 400 may be coupled to each of the first linkage components 206 at an intermediate location between the first ends 208 and the second ends 210. In an embodiment, the base portion 402 may be detachably fastened to the first linkage components 206. In another embodiment, the base portion 402 may be attached to the first linkage components 206 by welding. Alternatively, at least one of the first linkage components 206 and the tube member 400 may form a unitary construction. In the illustrated embodiment, the tube member 400 is a torque tube configured to minimize a bending of the first linkage components 206.

Further, the second linkage component 302 may also be pivotally connected to the first linkage component 206 via the tube member 400. The tube member 400 includes a pair of projecting portions 404A, 404B (also collectively referred to as “the projecting portions 404”) extending from the base portion 402 and coupled to the second linkage component 302. The projecting portions 404A and 404B may be spaced apart from each other. Further, each of the projecting portions 404 includes a first surface 406 facing the second linkage component 302 and a second surface 408 that is opposite to the first surface 406. The first surfaces 406 of the projecting portions 404 may receive a portion of the second linkage component 302 therebetween.

Moreover, the projecting portions 404 may be pivotally coupled to the second linkage component 302 at an intermediate location between the first end 304 and the second end 306 of the second linkage component 302. In the illustrated embodiment, each of the projecting portions 404 defines a mounting aperture 409 configured to be pivotally coupled to the second linkage component 302. In an example, the coupling between the projecting portions 404 and the second linkage component 302 may be accomplished by pivot pins received in each of the mounting apertures 409. However, a person of ordinary skill in the art will recognize that the second linkage component 302 may be coupled to the tube member 400 using various other mechanisms known in the art.

Referring still to FIGS. 3 and 4, one of the projecting portions 404, for example, the projecting portion 404A defines a slot 412 adjacent to an end 416 of the projecting portion 404A that is distal to the base portion 402. Further, a perimeter surface of the end 416 surrounding the slot 412 may extend adjacent to the second surface 408. The slot 412 may be configured to receive a mounting stud 414 therethrough. The mounting stud 414 may be coupled to the second linkage component 302 at one end while the other end may extend through the slot 412 adjacent to the second surface 408 of the projecting portion 404A. As such, the mounting stud 414 moves in conjunction with the second linkage component 302.

The lever member 424 is disposed adjacent to the slot 412 defined in the projecting portion 404A. Further, the lever member 424 is operatively coupled to the mounting stud 414 received in the slot 412. In the illustrated embodiment, the lever member 424 includes a fork section 426 that is disposed adjacent to the slot 412 and configured to receive the mounting stud 414. Moreover, the lever member 424 is supported on the mounting stud 414 at the fork section 426 so as to move along with the mounting stud 414. With such an arrangement, the lever member 424 may move in conjunction with the mounting stud 414 which in turn moves along with the second linkage component 302. As such, a movement of lever member 424 defines a movement of the second linkage component 302 which in turn defines a tilt movement of the implement 110.

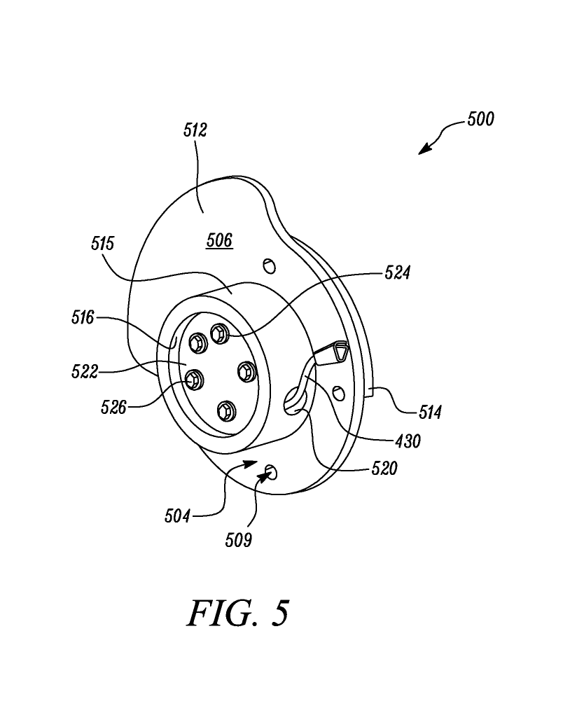

Referring to FIGS. 5 and 6, the guard system 500 also includes a cover member 502. The cover member 502 includes a body 504 having an external surface 506 and an internal surface 508. Further, the cover member 502 is configured to be coupled to the tube member 400 as illustrated in FIG. 3. Specifically, the cover member 502 may be coupled to the projecting portion 404A that defines the slot 412. Accordingly, the body 504 of the cover member 502 defines multiple holes 509 therethrough. Each of the holes 509 (shown in FIG. 5) may be configured to receive a fastening member 510 (shown in FIG. 3) therein. The fastening members 510 are configured to couple the cover member 502 to the projecting portion 404A of the tube member 400. In an example, the fastening members 510 may be bolts.

The body 504 may include one or more engaging members 514 projecting from the internal surface 508. The engaging members 514 may be configured to detachably engage with a recess 513 adjacent to the second surface 408 of the projecting portion 404A. Further, the recess 513 may be defined around the projecting portion 404A so as to receive the engaging members 514 therein. In the illustrated embodiment, the engaging members 514 may be annular segments and the projecting portion 404A may be substantially circular so as to correspondingly define the annular recess 513 thereabout. In another embodiment, there may be separate recesses 513 for each of the engaging members 514. Alternatively, the engaging members 514 may be defined adjacent to the second surface 408 of the projecting portion 404A. In such a case, the body 504 of the cover member 502 may define the recess 513 to detachably engage with the engaging members 514.

The internal surface 508 of the body 504 may also be configured to at least partly abut the second surface 408 of the projecting portion 404A. The body 504 may have a shape and a contour that at least partly confirms to a shape and contour of the second surface 408 of the projecting portion 404A. For example, the body 504 may include a slot cover portion 512 configured to cover the slot 412 defined in the projecting portion 404A. Specifically, the internal surface 508 of the slot cover portion 512 of the body 504 faces the second surface 408 of the projecting portion 404A so as to cover the slot 412 from one side. Further, an outer perimeter of the slot cover portion 512 may at least partly abut the perimeter of the projecting portion 404A surrounding the slot 412. The slot cover portion 512 of the body 504 and the second surface 408 also defines a recess (not shown) therebetween.

The body 504 also includes a cylindrical portion 515 extending from the external surface 506 of the body 504. The cylindrical portion 515 defines a cavity 516 configured to at least partly receive the sensing device 420 therein. The body 504 may further include an annular lip portion (not shown) extending inside the cavity 516. The sensing device 420 may be disposed adjacent to the annular lip portion of the body 504. The sensing device 420 may be disposed inside the cavity 516 such that the lever member 424 of the sensing device 420 is adjacent to the internal surface 508 of the body 504. Moreover, the lever member 424 is also disposed in the recess defined between the slot cover portion 512 of the body 504 and the second surface 408 of the projecting portion 404A.

As such, the lever member 424 may move in an angular range provided by the recess. Further, the lever member 424 is coupled to the mounting stud 414 so as to move in conjunction with the mounting stud 414 which in turn moves in conjunction with the second linkage component 302. The body 504 also defines an aperture 520 configured to allow the cable 430 of the sensing device 420 to pass therethrough.

The cover member 502 also includes a plate 522 disposed adjacent to the external surface 506 of the body 504. The plate 522 may be configured to enclose the sensing device 420 within the cavity 516. Moreover, the plate 522 may be supported on the annular lip portion so as to enclose the sensing device 420. Additionally or optionally, the plate 522 may also be coupled to the cylindrical portion 515. Specifically, the plate 522 may be coupled to the annular lip portion. In an example, the plate 522 may be coupled to the annular lip portion via welding.

Further, the plate 522 may be coupled to the sensing device 420. In the illustrated embodiment, the plate 522 may be removably coupled to the sensing device 420. The plate 522 defines one or more plate holes 524 that are configured to receive a sensor fastening member 526. The sensor fastening member 526 may be configured to couple the sensing device 420 to the plate 522. In an example, the sensor fastening member 526 may be a bolt and nut arrangement. In alternative examples, other types of fastening members 526 known in the art may be used to accomplish the coupling between the sensing device 420 and the plate 522.

### INDUSTRIAL APPLICABILITY

The present disclosure is related to the guard system 500 for the linkage assembly 200. The guard system 500 includes the tube member 400 and the cover member 502. The cover member 502 may be coupled to the projecting portion 404A of the tube member 400. The cover member 502 includes the body 504 and the plate 522. The body 504 includes the cylindrical portion 515 that defines the cavity 516 therethrough. The sensing device 420 may be disposed within the cavity 516. The cover member 502 also includes the plate 522 that encloses the sensing device 420 within the cavity 516.

Further, the lever member 424 of the sensing device 420 may be disposed within the slot 412 defined in the projecting portion 404A. The body 504 of the cover member 502 may also include the slot cover portion 512 that covers the slot 412. As such, the lever member 424 may be covered by the slot cover portion 512 of the body 504. Further, the body 504 also defines the aperture 520 for allowing the cable 430 of the sensing device 420 to pass therethrough.

Further, the guard system 500 provides the cover member 502 that is detachably coupled to the tube member 400. Further, the sensing device 420 may also be removably coupled to the cover member 502. As such, the guard system 500 facilitates replacement and/or maintenance of the sensing device 420.

The guard system 500 may be specifically advantageous in underground mining applications in which rocks, debris may routinely hit the linkage assembly 200. The guard system 500 of the present disclosure provides the sensing device 420 disposed with in the cavity 516 of the cover member 502. Further, the cover member 502 may be integrated with the tube member 400. As such, the tube member 400 and the cover member 502 together may effectively shield components of the sensing device 420 such as, the lever member 424 and the sensor body 422 from rocks and debris that may hit the linkage assembly 200 of the machine 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A guard system for a sensing device in a linkage assembly having a first linkage component and a second linkage component, the guard system comprising:
a tube member comprising:
a base portion coupled to the first linkage component; and
a projecting portion extending from the base portion and coupled to the second linkage component, the projecting portion having a first surface facing the second linkage component and a second surface opposite to the first surface; and
a cover member coupled to the projecting portion, the cover member comprising:
a body having an internal surface configured to at least partly abut the second surface of the projecting portion, and an external surface opposite to the internal surface, the body defining a cavity configured to receive the sensing device therein; and
a plate disposed adjacent to the external surface and configured to enclose the sensing device within the cavity, wherein the sensing device is coupled to the plate.

2. The guard system of claim 1, wherein the body further defines an aperture configured to allow a cable of the sensing device to pass therethrough.

3. The guard system of claim 1, wherein the body further comprises an engaging member projecting from the internal surface, the engaging member configured to detachably engage with a recess of the projecting portion.

4. The guard system of claim 1, wherein the body further defines a plurality of holes configured to receive a plurality of fastening members, the plurality of fastening member configured to couple the cover member to the projecting portion of the tube member.

5. The guard system of claim 1, wherein the plate defines a plurality of plate holes configured to receive a plurality of sensor fastening members, the sensor fastening members configured to couple the sensing device to the plate.

6. The guard system of claim 1, wherein the body comprises a cylindrical portion defining the cavity, and wherein the plate is coupled to the cylindrical portion.

7. The guard system of claim 1, wherein the projecting portion further defines a slot adjacent to an end distal to the base portion, the slot configured to receive a mounting stud of the sensing device therethrough, wherein the mounting stud is operatively connected to the second linkage component.

8. The guard system of claim 7, wherein the body further comprises a slot cover portion configured to cover the slot of the projecting portion.

9. The guard system of claim 1, wherein the projecting portion further defines a mounting aperture therethrough, wherein the mounting aperture is pivotally coupled to the second linkage component.

10. A machine comprising:
a frame;
an implement configured to perform an earth moving operation;
a linkage assembly configured to move the implement with respect to the frame, the linkage assembly comprising a tilt lever pivotally coupled to the implement and a lift arm coupled to the frame;
a sensing device associated with the linkage assembly;
a guard system for the sensing device, the guard system comprising:
a tube member comprising:
a base portion coupled to the lift arm; and
a projecting portion extending from the base portion and pivotally coupled to the tilt lever, the projecting portion having a first surface facing the tilt lever and a second surface opposite to the first surface; and
a cover member coupled to the projecting portion, the cover member comprising:
a body having an internal surface configured to at least partly abut the second surface of the projecting portion and an external surface opposite to the internal surface, the body defining a cavity configured to receive the sensing device therein; and
a plate disposed adjacent to the external surface and configured to enclose the sensing device within the cavity, wherein the sensing device is coupled to the plate.

11. The machine of claim 10, wherein the body further defines an aperture configured to allow a cable of the sensing device to pass therethrough.

12. The machine of claim 10, wherein the body further comprises an engaging member projecting from the internal surface, the engaging member configured to detachably engage with a recess of the projecting portion.

13. The machine of claim 10, wherein the body further defines a plurality of holes configured to receive a plurality of fastening members, the plurality of fastening member configured to couple the cover member to the projecting portion of the tube member.

14. The machine of claim 10, wherein the plate defines a plurality of plate holes configured to receive a plurality of sensor fastening members, the sensor fastening members configured to couple the sensing device to the plate.

15. The machine of claim 10, wherein the body comprises a cylindrical portion defining the cavity, and wherein the plate is coupled to the cylindrical portion.

16. The machine of claim 10, wherein the projecting portion further defines a slot adjacent to an end distal to the base portion, the slot configured to receive a mounting stud of the sensing device therethrough, wherein the mounting stud is operatively coupled to the second linkage component.

17. The machine of claim 16, wherein the body further comprises a slot cover portion configured to cover the slot of the projecting portion.

18. The machine of claim 1, wherein the projecting portion further defines an mounting aperture therethrough, wherein the mounting aperture is pivotally coupled to the tilt lever.

19. A sensor system for a linkage assembly having a first linkage component and a second linkage component, the sensor system comprising:
a sensing device comprising:
a sensor body;
a cable connected to the sensor body;
a lever member pivotally coupled to the sensor body; and
a mounting stud operatively connected to the lever member and the second linkage component;
a tube member comprising:
a base portion coupled to the first linkage component; and
a projecting portion extending from the base portion and coupled to the second linkage component, the projecting portion having a first surface facing the second linkage component and a second surface opposite to the first surface, the projecting portion further defining a slot adjacent to an end distal to the base portion, wherein the slot is configured to receive the mounting stud therethrough; and
a cover member coupled to the projecting portion, the cover member comprising:
a body having an internal surface configured to at least partly abut the second surface of the projecting portion and an external surface opposite to the internal surface, the body defining a cavity configured to receive the sensor body therein, the body further defining an aperture to allow the cable of the sensing device to pass therethrough; and
a plate disposed adjacent to the external surface and configured to enclose the sensor body within the cavity, wherein the sensor body is coupled to the plate.

20. The sensor system of claim 19, wherein the body further comprises a slot cover portion configured to cover the slot of the projecting portion.
